(19) United States
(12) Patent Application Publication
(10) Pub. No.: US 2021/0104963 A1
(43) Pub. Date: Apr. 8, 2021

(54) FIRST PATENT MAGNETIC PROPULSION METHOD

(71) Applicants: John R. Martinez, Walkersville, MD (US); Jeffrey J. Riddle, Georgetown, OH (US)

(72) Inventors: John R. Martinez, Walkersville, MD (US); Jeffrey J. Riddle, Georgetown, OH (US)

(21) Appl. No.: 16/591,113

(22) Filed: Oct. 2, 2019

(51) Int. Cl. H02P 9/02

(52) U.S. Cl. CPC H02P 9/02

(57) ABSTRACT

A rotating magnet electrical power generator. The apparatus may be used with any electrical generator that uses a rotating magnet assembly. A key aspect of the invention is the neutralization of one of the pair of rotating magnets, the neutralization occurring at predetermined intervals. Neutralization is effected by blocking the magnetic field of the stationary magnet using a cam operated metal enclosure or metal plates. The metal field blocker, which is made from mostly iron, is dynamically positioned in accordance with the relative positions of the stationary and rotating magnets. The iron enclosure (or plates) may be connected to a brushless servo or brushless stepper motor to precisely control the switching without a mechanical cam timing. In an alternative embodiment, the magnets are neutralized by stacking a pair of cylindrical magnets end to end, enclosing the magnets at least partially in a field blocking enclosure, and rotating the magnets relative to each other to effect neutralization.

### FIELD OF THE INVENTION

The present invention relates to power generation. More particularly, the invention discloses a device that generates electricity from a rotating magnet assembly.

### BACKGROUND OF THE INVENTION

Power generating devices using rotating magnet assemblies are well known in the art. Both generators and alternators run on the basic principle of producing electricity from an AC magnetic field. A type of power generator similar to the inventive device is shown in world patent number WO1990010337 issued to Troy Reed. According to the Reed patent “This is a magnetic motor having a crankshaft mounted between two stationary disk-like magnetic holders. Preferably eight permanent magnets are positioned equally distance about the periphery of each disk. Fixed on the end of each shaft is a rotatable magnetic support wheel which has a similar number of magnets equally spaced about its periphery. The magnets on one such wheel are 22½° out of alignment with the magnets on the other rotating wheel. Injector pins are mounted on a case above the crankshaft. Each such injector system has an injection drive pin which has intermittent contact with an injector pad driven up and down in the injector pin housing by rotation of the crankshaft. The pin injecting drive system includes the mechanism similar to that which is used to push out and retract the ball tip of ink writing pens. The magnets on each magnetic holder are 45° apart and the magnet on one fixed disk or stationary disk is in alignment with the permanent magnets of the permanent disk on the other end of the crankshaft. When the magnetic support wheel is rotated from the stop position the magnets will either attract or push and in the preferred embodiment they will push or be repulsive, that is the magnets on the permanent disk have the same polarity as the polarity on the rotating magnets which come in close proximity to each other, and are used to kick the crankshaft and the flywheel or the rotating magnetic support wheels over center so that the next propulsion force is created by the fixed rotary magnets will continue the rotational movement.” Reed recognizes that the wheel that spins will have a tendency to jerk as the two opposing magnets meet to repel each other. The opposing magnets cause a drag in the system which will lower the available output power delivered to a load. This problem can occur in any system using rotating magnets to generate power. The present invention eliminates the “jerk” by selectively neutralizing one of the pair of opposing magnets as they rotate past each other and thereby increases the output to the load, inherently allowing more stable rotation and greater efficiency.

The present invention is directed to a rotating magnet electrical power generator. The apparatus may be used with any electrical generator that uses a rotating magnet assembly. A key aspect of the invention is the neutralization of one of the pair of rotating magnets, the neutralization occurring at predetermined intervals. Neutralization is effected by blocking the magnetic field of the stationary magnet, using a cam operated metal enclosure or metal plates. The metallic field blocker, which is preferably made from mostly iron, is dynamically positioned in accordance with the relative positions of the stationary and rotating magnets. The iron enclosure (or plates) may be connected to a brushless servo or brushless stepper motor to precisely control the switching without mechanical cam timing. In an alternative embodiment, the magnets are neutralized by stacking a pair of cylindrical magnets end to end, enclosing the magnets at least partially in a field blocking enclosure, and rotating the magnets relative to each other to effect neutralization.

### SUMMARY OF THE INVENTION

It is a major object of the invention to provide an electrical power generator.

It is another object of the invention to provide an electrical power generator which uses stationary and rotating magnets to generate power.

It is another object of the invention to provide an electrical power generator which uses a rotating non-contact iron enclosure. The iron enclosure may be connected to a brushless servo or brushless stepper motor to precisely control the switching without mechanical cam timing.

It is another object of the invention to provide an electrical power generator which uses a mechanical cam timing method in order to neutralize/un-neutralize a plurality of static magnets so that a free spinning magnetic wheel is repelled in accordance with a predetermined schedule.

It is another object of the invention to provide an electrical power generator which uses a mechanical cam timing method in order to effect neutralization/un-neutralization of a plurality of static magnets so that the free spinning magnetic wheel is repelled in accordance with a predetermined timing pattern.

### BRIEF DESCRIPTION OF THE DRAWINGS

FIG. 1 shows a diametrically polarized stationary magnet positioned near a spinning magnet wheel.

FIG. 2 shows the combined cylindrical magnet assembly of the invention positioned near a spinning magnet wheel.

FIG. 3 shows supporting structure for the assembly of FIG. 2.

FIG. 4 shows supporting structure for the assembly of FIG. 2.

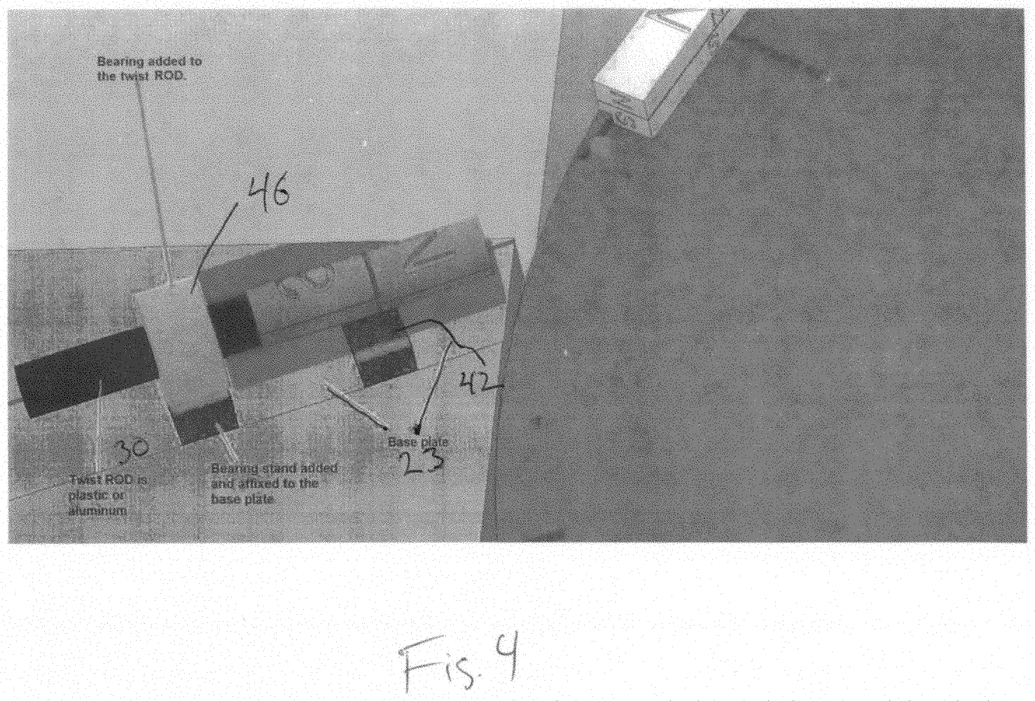

FIG. 5 shows supporting structure for the assembly of FIG. 2.

### DETAILED DESCRIPTION

The present invention is directed to a method of neutralizing a stationary magnet which stationary magnet is used to propel a series of magnets positioned on a spinning wheel or other rotating mechanism. U.S. Pat. No. 4,751,486 discloses a magnetic rotation apparatus having first and second rotors, which are supported and connected such that they can rotate in opposite directions in a cooperating manner. The first and second rotors include same number of permanent magnets arranged on their circumferential portions at regular intervals. One of the permanent magnets of one rotor is replaced with an electromagnet, which is connected to a drive circuit. The drive circuit includes a power source for supplying an electric current to the coil of the electromagnet. Each permanent magnet has one magnetic polarity located radially outward from the rotors and the other magnetic polarity located radially inward toward the rotors. The radially outward polarity of each permanent magnet is identical. When the first and second rotors are rotated in a cooperating manner, the phase of rotation of the permanent magnets of one of the rotors is slightly advanced from that of the permanent magnets of the other rotor. The device also employs a controlling drive circuit, similar to that disclosed by U.S. Pat. No. 5,594,289 for minimizing the electrical input applied to each magnetic motor.

U.S. Pat. No. 4,751,486 discloses a magnetic rotating apparatus, which comprises a rotating shaft, a first rotor fixed to the rotating shaft, and a second rotor rotating along with the first rotor is also fixed to the rotating shaft. Both the first and second rotors include a plurality of permanent magnets and balancers disposed thereon. Each of the permanent magnets is obliquely arranged with respect to the radial direction line of the rotor. The apparatus further includes a first electromagnet and a second electromagnet, which are magnetically connected and disposed facing the first and second rotors, respectively, for developing a magnetic field which faces the magnetic field of the permanent magnet means of the first and second rotors. The electromagnets intermittently energized based on the rotation of the rotor. The rotating principle involved in this apparatus is similar to that specified in U.S. Pat. No. 4,751,486.

As stated earlier, the rotor in an electrical generators such as Reed (see above) will have a tendency to jerk as the two opposing magnets meet to repel each other. The opposing magnets cause a drag in the system which will lower the available output power delivered to a load. This problem can occur in any system using rotating magnets to generate power. The present invention eliminates the “jerk” by selectively neutralizing one of the pair of opposing magnets as they rotate past each other and thereby increases the output to the load, inherently allowing more stable rotation and greater efficiency. It should be noted that this method is adaptable to any generator where stationary magnets are used to propel a spinning wheel, the environment illustrated is not the only environment where the invention can be practiced.

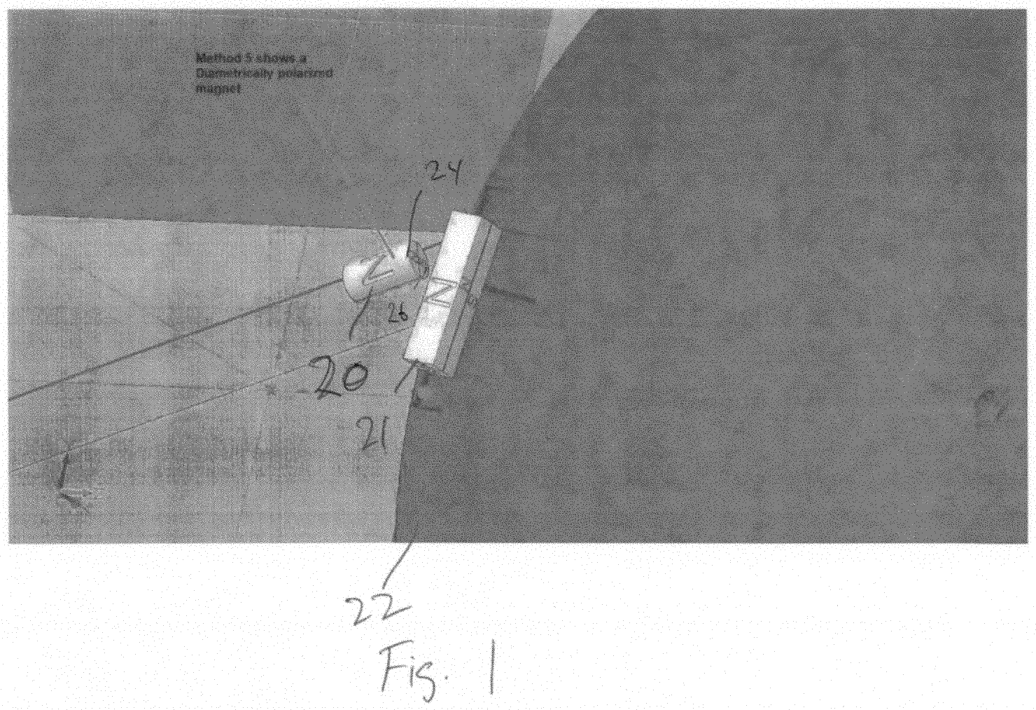

Referring now to FIG. 1, a single cylindrical magnet 20 being used to propel a magnet 21 positioned on a rotor or spinning wheel 22 is shown. This is a fairly standard arrangement which will produce the undesirable drag forces as discussed above. The magnet 20 is affixed to a base plate 23 which is used to position the magnet and hold it stationary.

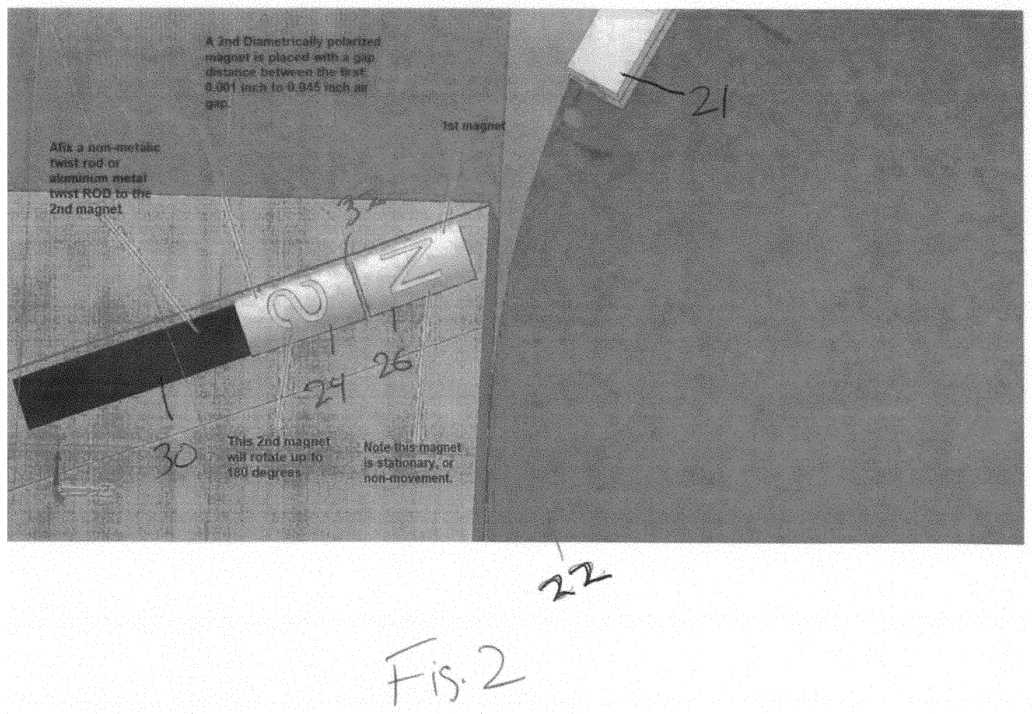

FIG. 2 shows a part of the combined magnet arrangement of the present invention. It can be seen that arrangement has two cylindrical, diametrically polarized magnets 24, 26. Magnet 24 is affixed to twisting rod 30 and rotates therewith, while magnet 26 is stationary. Magnet 24 is separated from magnet 26 by a gap 32, said gap may be from 0.0001 to 0.045 inches.

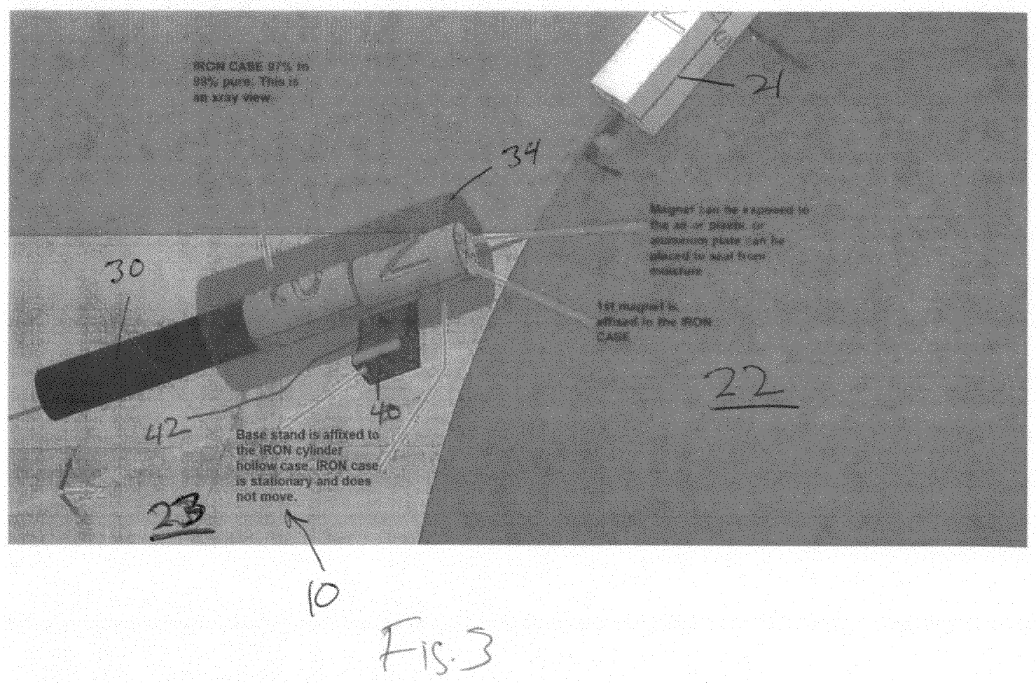

FIG. 3 shows the complete combined magnet arrangement 10 of the present invention showing the metal enclosure 34 which operates to effect neutralization when the magnets 24, 26 are rotated as will be explained in more detail later. The metal enclosure 34 is preferably formed of at least 97% iron. Magnet 26 is affixed in non rotational manner to enclosure 34. A base 40 having an arcuate cutout 42 is attached to the base plate 23, the cutout shaped to receive metal enclosure 34 which is essentially a cylindrical sleeve. The twisting rod 30 may be made of plastic or aluminum and can be operated by a servo mechanism or other means as would be apparent to one of skill in the art. A lever arm 44 is connected to twisting rod 30 in order to impart rotation thereto. The twisting rod 30 is positioned to go through a bearing 46 in order to smooth rotation.

A key aspect of the invention is the ability to neutralize a stationary magnet in accordance with a predetermined timing pattern, the pattern based on the velocity and position of the rotating magnets on a rotor. The neutralizing is effected by rotating magnet 24 relative to magnet 26 while both are positioned within enclosure 32. It should be noted that neutralization will not occur without enclosure 32 as would be apparent to one of skill in the art.

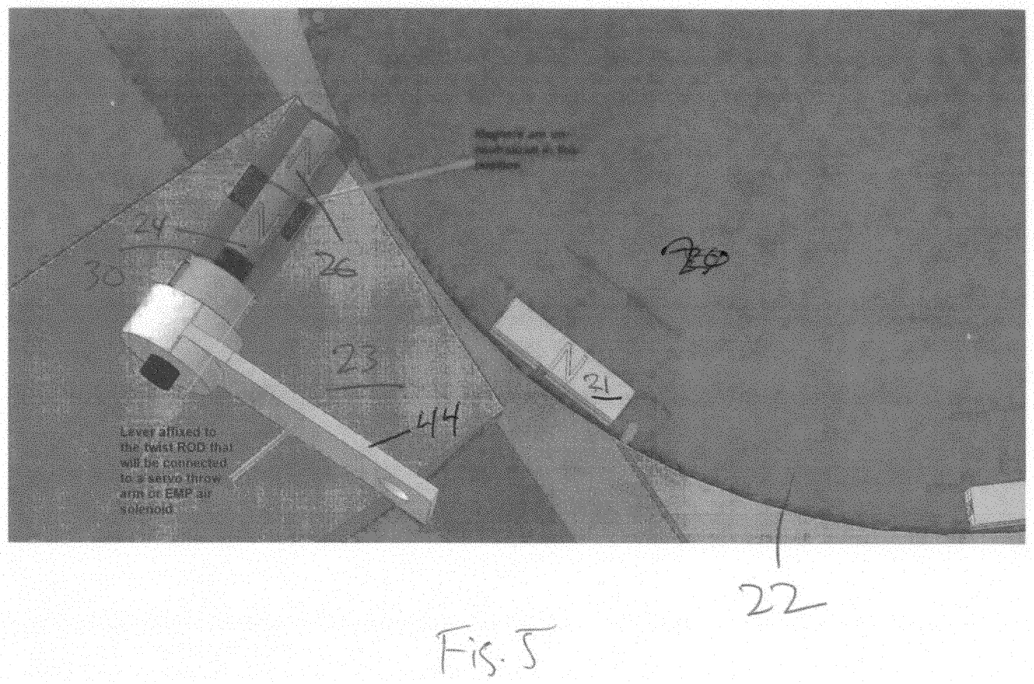

In operation, neutralization/activation is sequentially effected by rotating twisting rod 30 via lever arm 44. This is preferably done using a servo or like mechanism. When the magnets 24, 26 are aligned as shown in FIG. 5, the arrangement 10 is active or not neutralized. In this position, the north and south poles of the diametrically polarized magnets 26, 24 are aligned (north to north, south to south). FIG. 3 shows the arrangement almost in the neutral position. When the magnets 24, 26 are fully oriented in this position (north to south) the magnets are neutralized.

I claim:

1. A magnetic field neutralizing mechanism for use in an electrical generator having a rotating spinning magnet wheel propelled by at least one stationary magnet comprising:
an enclosure for said magnet, said enclosure formed of a metallic sleeve, said magnet being a combined magnet formed from two diametrically polarized magnets separated by a predetermined distance, one of said magnets being stationary and the other rotatable;
a mechanism for rotating said rotatable magnet relative to said stationary magnet;
wherein said combined magnet is neutralized or activated by rotating said rotatable magnet in accordance with a predetermined timing pattern.

2. The mechanism of claim 1 wherein said magnets are cylindrical.

3. The mechanism of claim 2 wherein said magnets are axially aligned and axially separated by said predetermined distance.

4. The mechanism of claim 3 wherein said predetermined distance is between 0.0001 to 0.045 inches.

5. The mechanism of claim 1 wherein said metallic sleeve is made from at least 97% iron.
